(19) United States
(12) Patent Application Publication
(10) Pub. No.: US 2026/0176977 A1
(43) Pub. Date: Jun. 25, 2026

(54) FIXED RADIAL INLET GUIDE VANES CONFIGURED TO DIRECT EXHAUST TO A TURBINE

(71) Applicant: Garrett Transportation I Inc., Torrance, CA (US)

(72) Inventors: Ashraf Mohamed, Torrance, CA (US); Kiran Siddappaji, Torrance, CA (US); Erwann Guillou, Torrance, CA (US); John Wilson, Torrance, CA (US)

(73) Assignee: Garrett Transportation I Inc., Torrance, CA (US)

(21) Appl. No.: 18/987,744

(22) Filed: Dec. 19, 2024

(51) Int. Cl. F01D 9/04; F02B 37/00

(52) U.S. Cl. CPC F01D 9/041; F02B 37/00; F05D 2220/40; F05D 2240/128

(57) ABSTRACT

Aspects herein related to fixed three-dimensional (3D) vane assemblies such as those for a turbocharger. In some instances, a fixed vane assembly comprises one or more platforms including a shroud, a hub, or both a shroud and a hub and a plurality of 3D fixed airfoil vanes coupled to the one or more platforms, each of the fixed 3D airfoil vanes comprising a pair of flow surfaces disposed between a leading edge and a trailing edge and a hub surface and a shroud surface, wherein the flow surfaces are formed of a plurality of cross-sectional layers taken along the vane height of each of the fixed 3D airfoil vanes, and wherein at least two or more of the layers have a different cross-sectional airfoil shape.

### BACKGROUND

Turbochargers uses internal combustion engine exhaust gas to increase the amount of air that enters an engine, which allows for more fuel to be burned and more power to be produced. While in E-Turbo arrangements, where an electric motor assists the gas-driven turbine in driving the compressor particular at times when exhaust gas flow is insufficient to produce the desired boost.

The turbine section can include a plurality of radial inlet guide vanes (stator vanes), sometimes also referred to as nozzles. In a radial inlet turbine, guide vanes are fixed or adjustable blades (vanes) located at the turbine's inlet that direct the incoming fluid flow tangentially towards the turbine rotor, minimizing flow disruptions, ensuring a smooth and efficient entry into the turbine blades, and maximizing energy extraction from engine exhaust gases. They are typically curved blades arranged in a circular pattern around the turbine inlet. The cross section of the vanes is called airfoil, the shape and curvature of an airfoil are critical to its performance. The curvature of an airfoil is known as its camber, and the angle at which the airfoil is positioned relative to the incoming gas flow is known as the angle of attack.

### OVERVIEW

Prior art turbine stages with two-dimensional (2D) vanes, may exhibit suboptimal performance, particularly for mixed flow applications, where a significant variation in gas incidence, pressure and velocities across the leading-edge span exist. Accordingly, the present disclosure has recognized that a need for three-dimensional (3D) inlet guide vanes that ensure a smooth and efficient gas entry for turbine wheels, particularly for mixed flow applications. Moreover, some prior art turbine vanes employ axial configured vanes (e.g., substantially axial-extending vanes) such as the vanes described in United States patent number 11,629,599 that have a curvilinear trailing edge and/or employ movable 2D vanes such as the vanes described in European patent number 3,048,253. However, such prior art vanes may be suboptimal at least in terms of torque and wear performance (e.g., which may be degraded due at least in part to the presence of the rotatable vanes, etc.), particularly for mixed flow applications in a turbocharger. While various references are made to mixed flow applications the present disclosure is not so limited and can relate to other applications such as radial flow applications (e.g., in radial flow turbines).

As detailed herein, the fixed three-dimensional (3D) vane assemblies herein employ a sophisticated 3D compound geometry of substantially radial extending vanes (e.g., as opposed to some prior art approaches that employ 2D vanes, substantially axial-extending vanes, and/or movable vanes). The fixed 3D vane assemblies herein utilize 3D vanes (3D airfoil vanes that are substantially axial-extending) where multiple airfoil cross-sectional layers are stacked (arranged) along the vane height with different angle of attack, with at least some (e.g., each) layer having different characteristics. These layers can vary in characteristics such as camber, chord length, twist angle and lean angle relative to each other and angle of attack relative to the incoming flow, and can be arranged either linearly or along a curved path along a 3D vane height. Additionally, the 3D vanes herein can incorporate both linear and non-linear swept (curved) edges, thus providing greater control over flow characteristics, among other benefits. The above-mentioned compound stacking arrangement can be optimal for mixed flow applications and has demonstrated significant efficiency improvements (e.g., of +1 to +2.2 points across different engine load conditions) compared to conventional 2D vanes in mixed flow applications. Hence, the 3D vanes herein can incorporate various different geometric features: twist angles, lean angles, and sweep angles in conjunction with varied chord lengths to realize optimized vane performance (e.g., optimized at least for the purpose of directing exhaust to a turbine wheel), particularly in mixed flow applications. In some embodiments, lean can also be perpendicular to the chord (true lean) and sweep along the chord (true sweep).

In a first aspect, a fixed three-dimensional (3D) vane assembly for a turbocharger is provided. The fixed vane assembly comprising: one or more platforms (e.g., a hub and/or a shroud); and a plurality of 3D fixed airfoil vanes coupled to the one or more platforms (e.g., coupled to the hub, the shroud or both the hub and the shroud), each of the fixed 3D airfoil vanes comprising a pair of flow surfaces disposed between a leading edge and a trailing edge and a hub surface, a shroud surface, or both the hub surface and the shroud surface, wherein the flow surfaces are formed of a plurality of cross-sectional layers taken along the vane height of each of the fixed 3D airfoil vanes, and wherein at least two or more of the layers have a different cross-sectional airfoil shape.

In some aspects, which may be used in conjunction with any of the other aspects herein, wherein the cross-sectional layers have different lean angles, different sweep angles, or both, relative to each other.

In some aspects, which may be used in conjunction with any of the other aspects herein, wherein a portion of at least some of the cross-sectional layers have non-zero twist angles.

In some aspects, which may be used in conjunction with any of the other aspects herein, wherein corresponding portions of the cross-sectional layers have different non-zero twist angles.

In some aspects, which may be used in conjunction with any of the other aspects herein, wherein the trailing edge, the leading edge, or both of the trailing edge and the leading edge are configured at a non-zero sweep angle.

In some aspects, which may be used in conjunction with any of the other aspects herein, the trailing edge and the leading edge are configured at a negative non-zero sweep angle.

In some aspects, which may be used in conjunction with any of the other aspects herein, wherein: a leading edge of a cross-section layer of the plurality of cross-sectional layers has a positive non-zero twist angle; and a leading edge of an additionally cross-sectional layer of the plurality of cross-sectional layers has a negative non-zero twist angle.

In some aspects, which may be used in conjunction with any of the other aspects herein, wherein the cross-sectional layer is a most proximate cross-sectional layer to a first platform, and wherein the additional cross-sectional layer is most proximate cross-sectional layer to a second platform.

In some aspects, which may be used in conjunction with any of the other aspects herein, further comprising one or more intervening layers disposed along the vane height between the cross-sectional layer and the additional cross-sectional layer.

In some aspects, which may be used in conjunction with any of the other aspects herein, wherein the one or more intervening layers has a twist angle that is between the positive non-zero twist of the cross-sectional layer and the negative cross-sectional twist of the additionally cross-sectional layer.

In some aspects, which may be used in conjunction with any of the other aspects herein, wherein at least two cross-sectional layers of the plurality of cross-sectional layers have different chord lengths.

In some aspects, which may be used in conjunction with any of the other aspects herein, wherein each cross-sectional layer of the plurality of cross-sectional layers has a different chord length.

In some aspects, which may be used in conjunction with any of the other aspects herein, wherein a chord length of each of the outermost cross-sectional layers of the plurality of cross-sectional layers are longer than a chord length of one or more intervening cross-sectional layers of the plurality of cross-sectional layers.

In some aspects, which may be used in conjunction with any of the other aspects herein, wherein a chord length of each of the outermost cross-sectional layers of the plurality of cross-sectional layers are different.

In another aspect, a turbocharger system is provided. The turbocharger system comprising: a turbine housing; a turbine wheel within the turbine housing; and a fixed three-dimensional (3D) vane assembly positioned upstream of the turbine wheel, the fixed vane assembly comprising: a plurality of 3D airfoil vanes, each 3D airfoil vane having multiple cross-sectional layers stacked along the vane height; wherein the multiple cross-sectional layers have different cross-sectional airfoil shapes and are arranged with variable lean and sweep angles relative to each other; wherein the multiple cross-sectional layers have non-zero twist angles that vary along the vane height, and wherein the multiple cross-sectional layers have different chord lengths.

In some aspects, which may be used in conjunction with any of the other aspects herein, wherein each of the cross-sectional layers are configured at different lean angles relative to each other in the span (axial) direction for each of the fixed 3D airfoil vanes.

In some aspects, which may be used in conjunction with any of the other aspects herein, wherein the 3D vane further comprises a first flow surface and a second flow surface positioned between a leading edge and a trailing edge of the 3D vane, and wherein the first flow surface, the second flow surface, or both the first flow surface and the second flow surface are configured at a non-zero lean angle.

In another aspect, a turbocharger nozzle assembly is provided. The turbocharger assembly comprising: an inner platform; an outer platform; and a plurality of fixed three-dimensional (3D) vanes extending between the inner platform and the outer platform, each 3D vane having: a compound stacked 3D airfoil geometry comprising multiple cross-sectional layers between a hub end and a shroud end; a non-zero twist angle between -5 and +5 degrees that varies the orientation of the cross-sectional layers along the vane height; a positive lean angle between 0 and 10 degrees; and a negative sweep angle between 0 and -25 degrees; wherein the compound stacked 3D airfoil geometry provides efficiency improvements of at least 0.9 points across engine load conditions between 25% and 100% load on the turbocharger nozzle assembly.

In some aspects, which may be used in conjunction with any of the other aspects herein, wherein the multiple cross-sectional layers are stacked linearly along the vane height.

In some aspects, which may be used in conjunction with any of the other aspects herein, wherein the multiple cross-sectional layers are stacked along a curved path along the vane height.

This overview is intended to introduce the subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an illustrative engine in schematic form in which the fixed three-dimensional (3D) vane assemblies herein can be utilized;

FIG. 2A illustrates a first view of a two dimensional (2D) prior art vane assembly;

FIG. 2B illustrates a second view of the 2D prior art vane assembly;

FIG. 2C illustrates a third view of the 2D prior art vane assembly;

FIG. 3A illustrates a first view of a 3D fixed vane assembly;

FIG. 3B illustrates a second view the 3D fixed vane assembly;

FIG. 3C illustrates a third view of the 3D fixed vane assembly;

FIG. 3D is a schematic representation of a top view of a 3D vane in the 3D fixed vane assembly of FIGS. 3A-3C;

FIG. 3E is a view from the perspective of the leading edge of the 3D vane of FIG. 3D;

FIG. 3F illustrates a view of an example orientation (lean angle) of the 3D vane of FIG. 3D;

FIG. 3G illustrates another view of an example orientation (sweep angle) of the 3D vane of FIG. 3D;

FIG. 3H illustrates views of various example orientations (twist angle) of the 3D vane of FIG. 3D;

FIG. 4 illustrates an exploded view of a 3D vane of a fixed 3D vane assembly; and

FIG. 5 illustrates a chart displaying examples of performance improvements yielded by the fixed 3D vane assemblies herein.

### DETAILED DESCRIPTION

The fixed vane assembly herein employ a sophisticated compound geometry that integrates variable cross-sectional shapes, lean angles, and sweep angles to optimize flow characteristics. The multiple cross-sectional layers are stacked along the vane height between the inner and outer platforms. At least some of the layers have different airfoil shapes. For instance, in some embodiments each layer has a different respective airfoil shape profile or cross-section. These varying cross-sections can operate in conjunction with the non-zero lean and sweep angles to create an optimized 3D flow path about the 3D vanes. In some embodiments, the lean angles, which tilt the shroud end (e.g., the most proximate surface to an adjacent shroud) in a direction along the y-axis relative to the hub end (e.g., a most proximate surface to an adjacent hub), combine with sweep angles that offset the shroud end along the x-axis to create a compound stacking arrangement. The fixed 3D vane assemblies, as detailed herein, can be either linear or curved along the vane height, allowing precise control of the flow field. The non-zero twist angles between layers further can enhance this control by varying a camber line orientation from hub to shroud. In some embodiments, cross-sectional layers within a stacked 3D vane can have different chord lengths, as described herein. These above-mentioned geometric features of the 3D vanes herein can permit the 3D vanes to better accommodate the different speeds and pressures that exist along the leading edge between hub and shroud in mixed flow applications (e.g., in turbochargers). That is, the fixed nozzle vane assembly, in some embodiments, incorporates three distinct geometric features (e.g., a non-zero twist angle, lean angle and sweep angle) that work together to optimize flow characteristics.

As used herein, a chord length refers to a straight-line distance between a leading edge and a trailing edge of an airfoil cross section of a vane. In some embodiments, the chord length of different cross-sectional layers of a vane (along the span direction from a hub layer to a shroud layer of a vane) can have different chord lengths, as detailed herein. In some embodiments, a chord length of the cross-sectional layers can be in a range from about 27 millimeters (mm) to about 30 mm, about 28 mm to about 30 mm, or about 28 to about 29 mm, among other possible values. In some embodiments, an absolute difference in chord length between cross-sectional layers (e.g., between directly adjacent cross-sectional layers) of a vane can be in a range from about 0.1 percent to about 10 percent, from about 0.1 percent to about 5 percent, or from about 1.0 percent to about 5 percent, among other possible values. These above dimensions and percentage difference in dimensions are merely examples and can be varied, for instance depending on a particular design of a vane and/or turbocharger. Employing cross-sectional layers with varying (different) chord lengths can promote aspects herein such as promoting creation of a compound stack arrangement along the span direction of the vane that exhibits desirable flow characteristics, particularly when used with mixed flow turbine stage designs.

As used herein, a twist angle refers to the torsion of the cross-sectional layers along the vane span (axial direction) around an axial-axis that can pass through a hub leading edge point, a hub trialing edge point, or any point laying on the camber line of the hub layer connecting the leading and trailing edges. Stated differently, the twist angle describes the rotational misalignment between successive layers about a stacking axis (perpendicular to the cross-sectional layers). In some embodiments, the non-zero twist angles herein can be in a range from about -5 degrees to +5 degrees. For instance, in some embodiments that employ one or more cross-sectional layers with a positive twist (downstream) angle the positive twist can be a in a range from about 0.1 degrees to about 5.0 degrees. Similarly, in some embodiments that employ one or more cross-sectional layers with a negative twist (upstream) angle the negative twist can be in a range from about -0.1 degrees to about -5.0 degrees. The above twist angles are merely examples and can be varied, for instance depending on a particular design of a vane and/or turbocharger. Employing a non-zero twist angle can promote aspects herein such as controlling flow direction by varying the airfoil orientation along the vane height.

As used herein, a lean angle refers to a tilt between an outer surface (e.g., a shroud surface) of a vane and an opposing outer surface (e.g., a hub surface) of the vane along (e.g., along a y-axis span direction). Stated differently, the lean angle describes the tilting of a layer relative to a vertical or reference axis. Lean angles can vary between one or more (e.g., all) of the cross-sectional layers of a vane. In some embodiments, a non-zero lean angle of a vane can be in a range from about 0.1 degrees to about 10 degrees, from about 1 degree to about 10 degrees, or from about 3 degrees to about 10 degrees. The above lean angles are merely examples and can be varied, for instance depending on a particular design of a vane and/or turbocharger. The non-zero lean angle can promote aspects herein such as promoting creation of a compound stack arrangement that exhibits desirable flow characteristics, particularly in mixed flow applications.

As used herein, a sweep angle refers to an offset along an x-axis between an outer surface (e.g., a shroud surface) of a vane and an opposing outer surface (e.g., a hub surface). Stated differently, a sweep angle represents a lateral shift or translation of a layer in the horizontal plane. In some embodiments, the non-zero sweep angle can be in a range from about -0.1 degrees to about -25 degrees. The non-zero sweep angle can promote aspects herein such as promoting creation of a compound stack arrangement the exhibits desirable flow characteristics, particularly in mixed flow applications.

The integration of the above-mentioned length and/or angular variations permits sophisticated control of the flow field. For example, the non-zero twist angle optimizes local flow angles, while the combination of non-zero lean and non-zero sweep angles creates a compound three-dimensional shape that better accommodates the varying speeds and pressures between hub and shroud. This geometric optimization has demonstrated significant performance improvements. That is, the fixed vane assembly herein yield measurable performance improvements across different engine load conditions, with efficiency gains. For instance, in mixed flow configurations the fixed vane assemblies herein can yield performance improvement of between 0.9 and 2.3 points across different engine load conditions. For example, the fixed vane assemblies herein can yield performance improvements of approximately 2.26 points at 25% load (PR1.25), 0.93 points at 75% load (PR2.6), and 2.18 points at 100% load (PR4), in some instances. Thus, the fixed nozzle assemblies herein can yield efficiency improvements of at least 0.9 points across engine load conditions between 25% and 100% load. As used herein, various “PR” values (e.g., PR1.25, PR2.6, and PR4) indicate the pressure ratios across the turbine stage at those respective load conditions. As used herein, various “point” values represent absolute percentage point improvements in efficiency, as compared to conventional 2D vanes at the same conditions (e.g., the same load conditions).

The performance improvements can be at least partly attributable to the 3D vane configurations herein providing direct and better control of a flow field, as compared to conventional 2D vane designs that have uniform cross-sections and zero lean/sweep angles. The 3D vane compound geometry allows the 3D vanes to maintain optimal incidence angles and minimize pressure losses across a wide operating range (e.g., of a mixed flow turbocharger). Hence, the 3D vanes herein can yield synergistic benefits attributable at least to the compound 3D vane geometries with varied geometries between one or more cross-sectional layers of the compound 3D vanes.

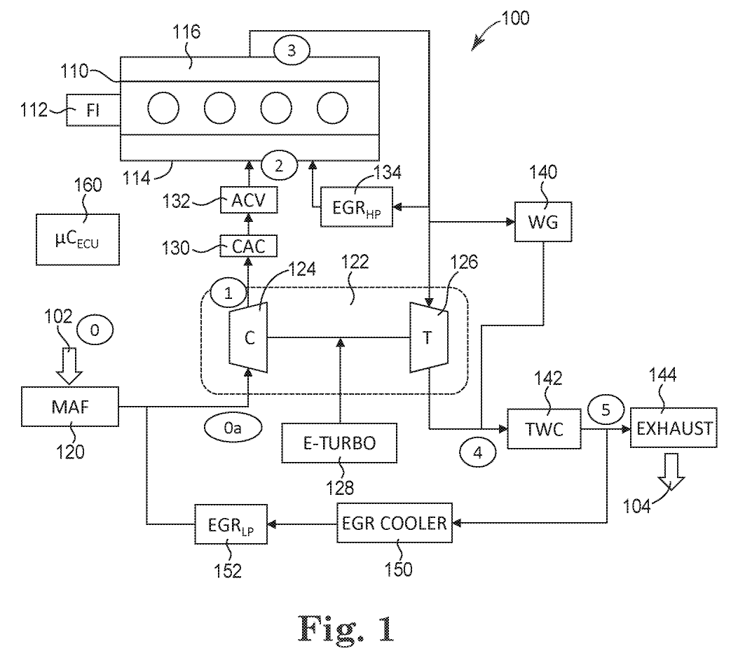

FIG. 1 is shown for context of the present new designs for the turbocharger. Briefly, an engine system is shown with focus on the airflow throughout. A turbocharger is provided to use torque obtained from a turbine wheel positioned in the exhaust airflow to turn a compressor that “charges” (increases the pressure of) incoming air to the engine. There are a range of reasons for doing this, well known in the art. Greater detail of the various components shown is provided below.

FIG. 1 shows an illustrative engine in schematic form. The system 100 includes an engine 110 having an (air) intake manifold 114, and exhaust manifold 116 and a plurality of cylinders. The engine cylinders receive fuel input by fuel injectors 112. Each fuel injector 116 is adapted to provide a variable charge of fuel for each cycle of the cylinder (generally). The amount of fuel injected is determined by a control signal.

The air system of the engine system 100 is shown in some detail. Ambient air 102 is received and filtered to remove particulates by an air filter (not shown), which is followed by a mass air flow (MAF) sensor 120. The MAF sensor 120 determines a mass flow entering the system. The MAF sensor 120 may be omitted in some systems.

As used herein, when air passes through an element, the position before the air passes through the element is referred to as “upstream,” and the position after the air passes through the element is referred to as “downstream.” For example, as shown, air passes through the MAF sensor 120 and then goes to the compressor 124 of turbocharger 122, therefore the compressor 124 is downstream of the MAF sensor 120, and the MAF sensor 120 is upstream of the compressor 124. Ambient air conditions may be sensed as indicated at position 0 with pressure, temperature and/or other sensors to determine, for example and without limitation, ambient air pressure, temperature and humidity as air flow 102 enters the system.

In the example shown, the air passing through the MAF sensor 120 goes to a compressor 124 of a turbocharger 122. The turbocharger 122 provides torque to the compressor 124 from a turbine 126 positioned in the exhaust gas airflow from the engine 110. Using this torque, the compressor 124 will compress the air, raising the pressure and temperature thereof, which may also be referred to as charging the air. Air pressure at the intake to the compressor 124 (position 0a) can be estimated from a model using the output of the MAF sensor 220 and ambient conditions at position 0. In some configurations, a pressure sensor may be provided at the output of the compressor, providing a boost pressure measurement for position 1. In some other configurations the pressure at position 1 may be calculated or estimated from a model using, for example a throttle model and a sensed pressure at the intake manifold of the engine 110. Optionally, the turbocharger 122 may include an E-Turbo motor 128 which obtains electrical power from the engine output (the drive shaft, for example) and may be associated with a battery if desired.

To enhance efficiency of the engine 110 (and limit temperature extremes) the compressed air then passes through a charge air cooler (CAC) at 130. Downstream of the CAC 130 is an adjustable choke valve (ACV), shown at 132. The ACV 132 serves as the throttle in the system 100. A recirculation valve (RCV) may be included, if desired. The RCV may be placed to allow recirculation of the output of the compressor back to its input, enabling prevention of turbocharger surge and operating to reduce pressure at the compressor output if the ACV 132 is closed, for example.

Air passing through the ACV 132 goes to the engine intake manifold 114. An intake manifold absolute pressure sensor and temperature sensor are provided at the intake manifold, providing pressure and temperature readings at position 2. The air enters the cylinders of the engine 110, where combustion with fuel injected by the fuel injector 112 occurs. Following combustion, the air, now mixed with fuel (at least some of which has combusted) exits the engine at the exhaust manifold 116. Temperature at location 3, as shown, can be estimated according to a model by the system monitor using several inputs including the measured conditions at position 2 along with engine speed and fuel injection parameters, where the engine speed is measured by well-known magnetic measuring device, and fuel injection parameters are obtained from the fuel injector 112 control signal. Further inputs for estimating temperature at location 3 may include estimated charge mass flow (summation of the measured mass through the MAF sensor and estimated EGR flow) and, typically, using ignition angle and air-to-fuel ratio. Although pressures and temperatures along the exhaust side may be measured if desired, this is not typically the case. Instead the exhaust side temperatures and pressures are typically estimated using the air path model, accounting for individual component models described below and can be computed by solving a set of equations which are then solved iteratively.

The exhaust gasses from the exhaust manifold 116 are directed back to the turbocharger 122 and power the turbine 126. A portion of these exhaust gasses may be circulated back to the intake manifold through a high-pressure exhaust gas recirculation (EGR) valve 134 (which may also be use with an EGR cooler, not shown), where the inert recirculating gas can be used to enhance combustion properties including reducing combustion temperatures.

As the exhaust air passes through the turbine 126, the turbine spins and drives the compressor 124, with or without aid from the E-Turbo 128. The turbine 126 and/or compressor 124 of the turbocharger 122 may include variable geometries, if desired. For example, turbine 126 may be a variable nozzle turbine (VNT). The E-Turbo 128 may, optionally, enhance operation of the turbocharger 122, particularly at low engine speeds where the turbine 126 may not provide sufficient force to the drive the compressor 124 to sufficiently charge the airflow to desired pressure levels.

A wastegate (WG) 140 is provided to control the turbocharger 122. In the design shown, the WG 140 is a controllable valve that selectively allows exhaust gasses from the exhaust manifold 116 to bypass the turbine 126. To increase turbocharger 122 speed, the WG 140 position is modified to reduce the quantity of gas passing through the WG 140; conversely, to reduce turbocharger 122 speed, the WG 140 position is modified to allow more gas through the WG 140. In some examples only one of the VNT or WG 140 is included, though both may be included in other examples.

Pressure and temperature at position 4, exiting the turbine 126, can be estimated from an iterative problem solution, determining estimates in a counter-flow manner starting from ambient pressure at the exhaust port (tail pipe, for example) and working backward to the exhaust manifold for pressures, and for temperatures starting with the exhaust manifold temperature and working downstream to positions 3, 4 and 5. After exiting the turbine, the exhaust gasses are subjected to after-treatment, here shown as a three-way catalytic (TWC) converter unit 142. The design shown may be for a gasoline engine; different and/or additional aftertreatment components may be included for other fuels. For example, a diesel engine may include a particulate filter, NOx trap, etc., as desired.

A low pressure EGR system is provided, with an EGR cooler 150 and a low pressure EGR valve 152, coupled to the exit of the TWC 142. The exhaust gasses are first cooled by the EGR cooler 150 and then pass through the EGR valve 152. By recirculating exhaust gasses, the composition of the airflow into the compressor 124 can be controlled. The use of an EGR, generally, is well known in the art as allowing the introduction of inert gasses into the combustion chamber of the engine. Typically, low pressure EGR 152 may also be used in a gasoline engine to reduce throttling or pumping losses and/or engine knocking. In the context of a diesel engine, high pressure EGR 134 can be useful to reduce certain environmentally harmful emissions, particularly NOx. Some examples may use a three-way EGR valve that controls both airflow from the MAF sensor and airflow from the EGR cooler 150. Some examples may omit EGR entirely or may have only one of the high pressure EGR 134 and low pressure EGR 152.

Numerous prior art references disclose control systems that can be implemented as the engine control unit 160, which may be implemented as a controller. The controller may take many forms, including, for example, a microcontroller or microprocessor, coupled to a memory storing readable instructions for performing methods as described herein, as well as providing configuration of the controller for the various examples that follow. The controller may include one more application-specific integrated circuits (ASIC) to provide additional or specialized functionality, such as, without limitation a signal processing ASIC that can filter received signals from one or more sensors using digital filtering techniques. Logic circuitry, state machines, and discrete or integrated circuit components may be included as well. The skilled person will recognize many different hardware implementations are available for a controller.

In a turbocharger, the fixed vane assemblies can be positioned upstream of the turbine wheel in the turbine housing to direct exhaust flow. Specifically, the 3D vanes are located between the exhaust manifold and turbine wheel, where the 3D vanes receive exhaust gases from the engine's exhaust manifold through a volute passage. The 3D vanes can direct this exhaust flow to the turbine wheel (e.g., at an angle thereto) to extract energy and drive the compressor. For instance, the fixed vane assembly's location can permit the fixed vane assembly to convert at least a portion of the engine's exhaust energy into kinetic energy to drive the turbine wheel. For example, in the turbocharger system layout, the 3D vanes can be positioned after the high-pressure EGR takeoff point and before the turbine wheel inlet, thereby permitting the 3D vanes to control both the flow direction and a pressure ratio across one or more turbine stages.

While the description and various Figures herein pertain to fixed vane assemblies employed in a particular location (e.g., upstream of a turbine housing) in turbochargers, the present disclosure is not so limited. Rather, in some embodiments, the fixed vane assemblies can be employed in different locations with respect to a turbocharger and/or can be employed in different structures such as being located in or proximate to (e.g., downstream from) a compressor or other type of structure (e.g., a pump, etc.).

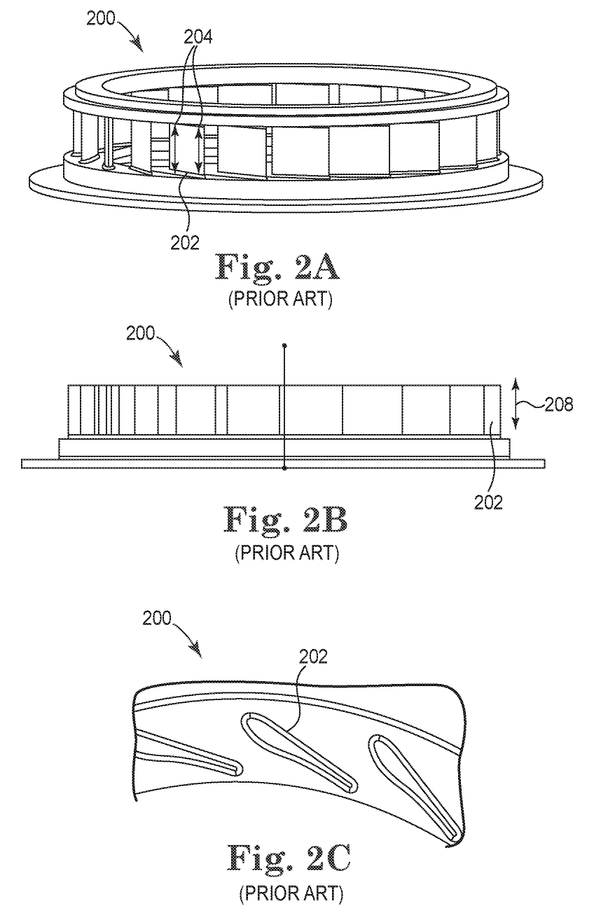

As mentioned, some prior art approaches employ 2D vanes in fixed vane assemblies. FIGS. 2A-2C illustrate respective views of an example of a 2D prior art vane assembly 200. Specifically, FIG. 2A illustrates a first (perspective) view of the 2D prior art vane assembly 200, FIG. 2B illustrates a second (elevation) view of the 2D prior art vane assembly 200, and FIG. 2C illustrates a third (top) view of the portion of the 2D prior art vane assembly 200. As illustrated in FIG. 2A, the 2D prior art vane assembly 200 includes a plurality of 2D vanes such as the vane 202 that each has a zero-degree sweep angle (e.g., both the trailing edge and the leading edge of the vane 202 have a zero-degree sweep angle), as illustrated at 204.

Additionally, as illustrated in FIGS. 2A-2B, the 2D prior art vane assembly 200 with the 2D vanes including the vane 202 each have the same (uniform) cross-sectional length. In addition, as illustrated in FIG. 2C, the 2D prior art vane assembly 200 with the 2D vanes including the vane 202 each have the same shape along an entire height 208 of the respective 2D vanes. For instance, each of the 2D vanes in the prior art vane assembly 200 each has a zero-degree twist angle, has zero lean angle, and has a uniform chord length along the entire height of the 2D vanes. That is, as illustrated in FIGS. 2A-2C, the 2D vanes can be uniformly stacked along the entire vane height 208, e.g., with zero sweep (zero-degree sweep) edges and consistent cross-sectional length throughout. The 2D conventional vane design illustrated in FIGS. 2A-2C results in suboptimal performance (e.g., in terms of turbocharger efficiency, etc.), particularly for mixed flow applications where different speeds and pressures exist along the leading edge between hub and shroud of a turbocharger.

Alternatively, or in addition, to the 2D prior art vane assembly 200, some prior art approaches may employ vane assemblies with movable (e.g., rotatable) vanes. For instance, European patent number 3,048,253 discloses prior art movable vanes with a 2D airfoil contour or profile that is simply extruded along a vane axis (e.g., maintains a uniform cross-sectional and/or chord length along a vane height) and aligns with the vanes post/rotational axis about which the vanes (e.g., 2D vanes) are configured to rotate. However, such prior art vanes may be suboptimal at least in terms of torque and wear performance (e.g., which may be degraded due at least in part to the presence of the rotatable vanes), particularly for mixed flow applications in a turbocharger.

Accordingly, the present disclosure is directed to fixed vane assemblies employing 3D vanes such as those with variable cross-sections, non-zero lean/sweep angles, and/or compound stacking arrangements, as described herein. For example, the fixed vane assemblies herein can include one or more platforms (e.g., a hub and/or a shroud) and a plurality of three-dimensional (3D) fixed airfoil vanes coupled to the one or more platforms (e.g., from the hub, the shroud, or both the hub and the shroud). Hence, in some embodiments, the one or more platforms can be manifested as various components in a turbocharger such as a shroud, a hub, and/or a combination of a shroud and a hub. However, in some embodiments the one or more platforms can be manifested as a different type of platform such as various components in a compressor and/or a pump. As used herein, the 3D airfoils being “fixed” refers to one or more surfaces of the 3D vanes herein being permanently coupled to another surface (e.g., a hub, a shroud, or both) in a non-movable (e.g., non-rotatable) manner. For instance, a first surface (e.g., a shroud surface) of the 3D vanes, a second surface (e.g., a hub surface) of the 3D vanes, or both the first surface and the second surface can be coupled to one or more platforms in a non-movable (e.g., non-rotatable) manner.

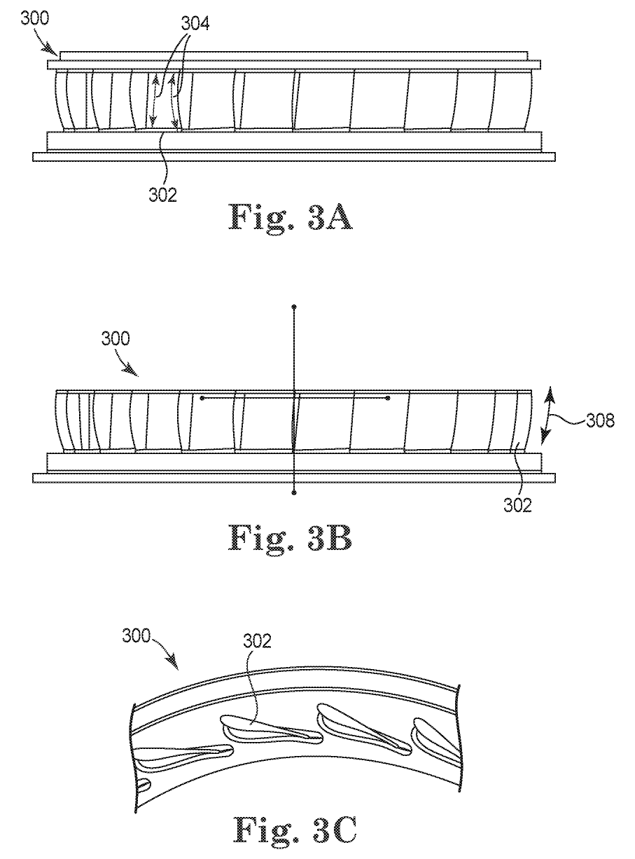

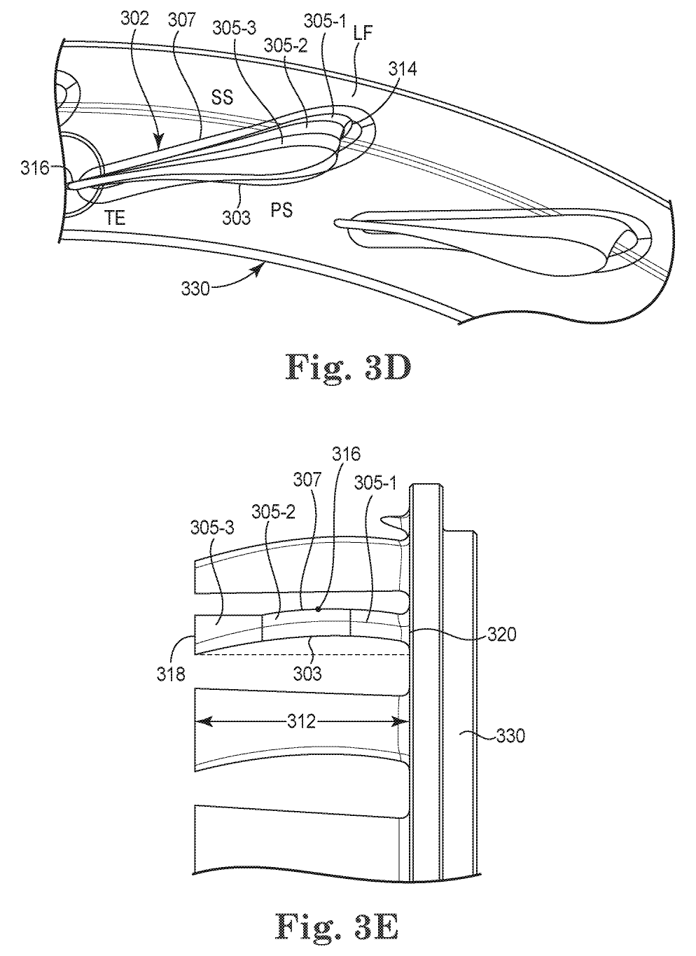

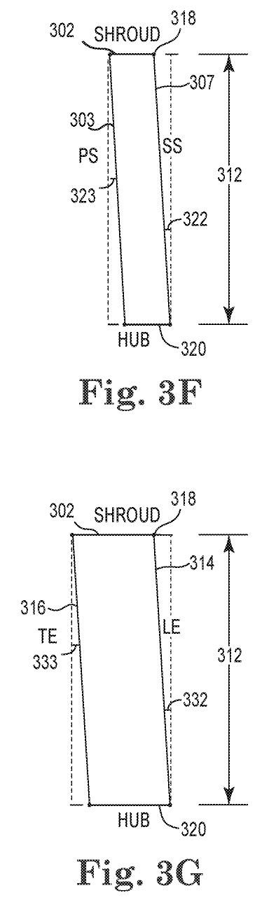

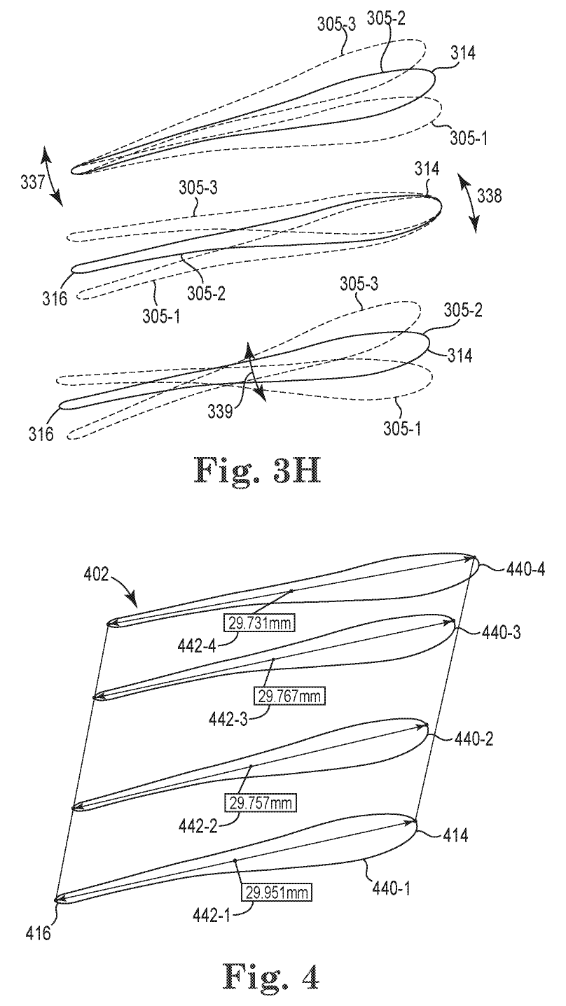

The 3D fixed airfoil vanes herein can be inlet vanes which are positioned upstream of a turbocharger inlet, as detailed herein. The 3D fixed airfoil vanes can each have the same shape (e.g., with the same non-zero twist and/or non-zero lean angles, etc.) and same size (e.g., with the same nozzle height with the same chord length e.g., as taken at one or more of the cross-sectional layers, as detailed herein). The 3D fixed airfoil vanes herein can include a pair of flow surfaces disposed between a leading edge and a trailing edge and a hub surface and a shroud surface, where the flow surfaces are formed of a plurality of cross-sectional layers taken along a vane height of each of the fixed 3D airfoil vanes, and at least two or more of the layers have a different cross-sectional airfoil shape, as detailed herein. For instance, as illustrated in FIG. 3A, a 3D vane assembly 300 herein can include a plurality of 3D vanes such as the vane 302 that each has a non-zero sweep angle (e.g., one or both of the trailing edge and/or leading edge of the vane 302 have a non-zero sweep angle), as illustrated at 304.

Additionally, as illustrated in FIG. 3B, the 3D fixed vane assembly 300 with the 3D vanes including the vane 300 each have the varying (non-uniform) cross-lengths along a height 308 of the 3D vanes. Stated differently, the 3D vanes herein can be formed of a plurality of cross-sectional layers (located between a trailing edge and a leading edge of the 3D vanes) taken along a vane height 308 of each of the fixed 3D airfoil vanes, where some or all of the cross-sectional layers have different chord lengths, as detailed herein.

As illustrated in FIG. 3C, the 3D fixed vane assemblies herein can be comprised of (e.g., only include) 3D airfoil vanes that are substantially axial-extending, unlike some prior art approaches such as those described herein that employ substantially radially-extending vanes. In addition, as illustrated in FIG. 3C, the 3D fixed vane assembly 300 with the 3D vanes including the vane 302 each have the same shape along an entire height of the respective 3D vanes. Stated differently, the some or all of the plurality of cross-sectional layers taken along a vane height of each of the fixed 3D airfoil vanes, wherein some or all of the cross-sectional layers have 3D shapes, as detailed herein.

In some embodiments, the 3D vanes herein can include a plurality of cross-sectional layers having different lean angles, different sweep angles, or both. For example, the 3D vanes herein can include a plurality of cross-sectional layers having different twist angles along a vane height. FIG. 3D is a schematic representation of a top view of the vane 302 in the 3D fixed vane assembly 300 of FIGS. 3A-3C. As mentioned, the vane 302 can be coupled to one or more platforms. For instance, as illustrated in FIG. 3D, the vane can be coupled to a hub 330.

As illustrated in FIG. 3D, the vane 302 can include a plurality of flow surfaces 303, 307. The flow surfaces 303, 307 can be disposed between a leading edge (LE) 314 and a trailing edge (TE) 316 of the vane 302. The flow surfaces 303, 307 can have different shapes, as detailed herein. The flow surfaces 303, 307 can be opposing surfaces of the vane 302, as illustrated in FIG. 3D. The flow surface 303 can be a pressure surface (PS) of the vane 302 and the flow surface 307 can be a suction surface (SS) of the vane 302. However, other configuration of the flow surfaces 303, 307 are possible.

The vane 302 can have a vane height (e.g., vane height 312, as illustrated in FIG. 3E) between a first (e.g., shroud) surface 318 and a second (e.g., hub) surface 320. The vane height 312 can be comprised of a plurality of cross-sectional layers 305-1, 305-2, 305-3 (collectively referred to herein as cross-sectional layers 305). The plurality of cross-sectional layers 305 herein refer to respective cross-sections or cross-sectional areas taken along the vane height 312. As illustrated in FIGS. 3D-3E, each of the cross-sectional layers 305 can have the same height (along a portion of the vane height 312). However, as detailed herein, in some embodiments two or more of the cross-sectional layers 305 can have different shapes (e.g., different twist angles, etc.) and/or different chord lengths.

In some embodiments, a first cross-sectional layer 305-1 can be referred to as a lowest layer along a vane height 312, and another cross-sectional layer such as a third cross-sectional layer 305-3 can be referred to an upper layer along the vane height. For example, the first cross-sectional layer 305-1 can be the lowest cross-sectional layer that is most proximate to or is coupled to a first platform (e.g., a hub) and the second cross-sectional layers 305-3 can be a highest (most distal relative to the hub) cross-sectional layer that is most proximate to or is coupled to a second platform (e.g., a shroud).

The cross-sectional layers 305 can be stacked cross-sectional layers (e.g., that are substantially stacked along a common axis extending co-extensive with the vane height 312). The cross-sectional layers can be stacked linearly along the vane height 312 or can be stacked along a curved path along the vane height. For example, FIG. 3E illustrates of the vane 302 of FIG. 3D from the perspective of a leading edge 314 of the vane 302. As illustrated in FIG. 3E, the plurality of cross-sectional layers 305 can be stacked along a curved path (e.g., having a curvature that is substantially similar to or mirrors a curvature of the flow surface 303) along the vane height 312.

In some embodiments, a portion of at least some of the cross-sectional layers can have non-zero twist angles. For example, corresponding portions of the cross-sectional layers can have different non-zero twist angles. The corresponding portions of the cross-sectional layers refer to portions of the cross-sectional layers that are taken at different positions along the vane height, but are located at the same relative position between the trailing edge and leading edge. For instance, as illustrated in FIG. 3D, at least the portion of the cross-sectional layers that forms the leading edge 314 of the vane 302 can have non-zero twist angles. That is, the leading edge of the at least some of the cross-sectional layers have non-zero twist angles. In some embodiments, the portion of the cross-sectional layers 305 that form the leading edge 314 of the vane 302 can have non-zero twist angles and the portion of the cross-sectional layers 305 form the trailing edge 316 of the vane 302 can have a zero-twist angle, as illustrated in FIG. 3D. That is, each of the cross-sectional layers 305 can have a zero-twist angle at the portion of cross-sectional layers 305 that forms the trailing edge 316 of the vane. Stated differently, the trailing edge 316 of the cross-sectional layers 305 can have a zero-degree twist angle, while the leading edge 314 of the cross-sectional layers 305 can have a non-zero twist angle.

As illustrated in FIGS. 3D-3E, the vane 302 can be configured with a non-linear twist. For instance, the non-linear twist can change (in angle) about an inflection point 317 in the twist direction that is located along the vane height 312. Hence, the vane 302 can have a first twist direction (e.g., a forward twist direction) on a first side of the inflection point 317 and can have a second twist direction (e.g., a reverse twist) on the second side of the inflection point 317. For example, as illustrated in FIG. 3D, at least a first cross-sectional layer 305-1 can have a first twist direction, one or more intervening layers such as the second cross-sectional layer 305-2 can have a different twist direction and/or angle (e.g., a reduced twist angle) than the first cross-sectional layer 305-1, and a third cross-sectional layer 305-3 can have a different twist direction (e.g., a reverse or backward twist direction) and/or angle than at least the first cross-section layer 305-1. That is, a leading edge portion of a first cross-section layer 305-1 can have a positive (forward) non-zero twist angle and a leading edge portion of another cross-sectional layer such as the third cross-sectional layer 305-3 can have a negative (backward) non-zero twist angle. As used herein, the one or more intervening layers (e.g., the second cross-sectional layer 305-2) refer to cross-sectional layers located between the first cross-sectional layer 305-1 and the third cross-sectional layer 305-3. In some embodiments, the one or more intervening layers such as the cross-sectional layer 305-2 can a twist angle (e.g., a non-zero twist angle or zero-twist angle) that is between a positive non-zero twist angle of the first cross-sectional layer (e.g., 305-1) and the negative non-zero twist angle of the third cross-sectional layer (e.g., 305-3).

Hence, as illustrated in FIG. 3D, each of the respective cross-sectional layers of the vane 302 can have different twist directions and different twist angles. For instance, the outmost layers such as the cross-sectional layers 305-1 and 305-3 can have twist angles that are greater than a twist angle of one or more intervening layers such as the cross-sectional layer 305-2. As used herein, the outermost cross-sectional layers refer to the cross-sectional layers that are configured to contact or are in contact with one or more platforms (e.g., the one or more platforms are manifested as a hub and/or a shroud).

In some embodiments, a respective twist angle of each of the cross-sectional layer of the cross-sectional layers 305 can be uniform or can vary along a height of the cross-sectional layer. For instance, a twist angle of the outermost cross-sectional layers (e.g., 305-1 and 305-3 in FIG. 3D) can be uniform along a height of the cross-sectional layers (e.g., along the portion of the vane height attributable to the outermost cross-sectional layers), while a twist angle of one or more intervening layers (e.g., cross-sectional layer 305-2) can vary along the height of the one or more intervening layers. Employing one or more intervening layers with a twist angle that varies along the height of the one or more intervening layers can permit the one or more intervening layers to mirror respective twist angles of adjacent surfaces of the outermost layers, as illustrated in FIG. 3D.

In some embodiments, the 3D vanes herein can be configured at a non-zero lean angle. For instance, a trailing edge, a leading edge, or both the trailing edge and the leading edge can be configured at a non-zero lean angle. In some embodiments, the trailing edge and the leading edge can be configured at different respective lean angles or the same respective lean angle. Hence, at least some or all of a plurality of cross-sectional layers can be configured with a non-zero lean angle. For instance, FIG. 3F illustrates a view of an example orientation (lean angle) of the 3D vane 302 of FIG. 3D. As illustrated in FIG. 3F, the vane 302 can include a flow surfaces 303, 307 disposed between the leading edge (LE) (e.g., leading edge 314, as illustrated in FIG. 3D) and the trailing edge (e.g., trailing edge (TE) 316, as illustrated in FIG. 3D) of the vane 302. The flow surface 303 (e.g., a first flow surface) can correspond to a pressure side (PS) of the vane 302. The opposing flow surface 307 (e.g., a second flow surface) can correspond to a suction side (SS) of the vane 302. The vane 302 can have a vane height 312 between a first (e.g., shroud) surface 318 and a second (e.g., hub) surface 320.

As illustrated in FIG. 3F, the flow surfaces 303, 307 can have a non-zero degree lean angles. For instance, the non-zero lean angle (e.g., non-zero angles 322, 323) can be in a range from about -0.1 degrees to about -5 degrees. For instance, as illustrated in FIG. 3F, each of the flow surfaces 303, 307 can be configured at a non-zero lean angle, as indicated by elements 323 and 322, respectively. In some embodiments, the flow surfaces 303, 307, can be configured at the same non-zero degree lean angle. In some embodiments, a non-zero lean angle of a vane can be in a range from about 0.1 degrees to about 10 degrees, from about 1 degree to about 10 degrees, or from about 3 degrees to about 10 degrees. The above lean angles are merely examples and can be varied, for instance depending on a particular design of a vane and/or turbocharger. The non-zero lean angle can promote aspects herein such as promoting creation of a compound stack arrangement that exhibits desirable flow characteristics, particularly in mixed flow applications.

FIG. 3G illustrates another view of an example orientation (sweep angle) of the 3D vane 302 of FIG. 3D. For instance, the flow surface trailing edge 316 and/or the leading edge 314 of the vane can have a non-zero sweep angle. As illustrated in FIG. 3G, each of the trailing edge 316 and the leading edge 314 can be configured at non-zero sweep angles, as indicated by elements 333 and 332, respectively. In some embodiments, each of the trailing edge 316 and the leading edge 314 can be configured at the same non-zero sweep angle. The non-zero sweep angle can be a value in a range from about a negative sweep angle between 0 and -25 degrees, about -1 to about -25 degrees, or about -1 to about -15 degrees.

FIG. 3H illustrates views of various example orientations (twist angles) of the 3D vane 302 of FIG. 3D. The non-zero twist angles between cross-sectional layers e.g., cross-sectional layers 305-1, 305-2, 305-3 further can enhance this control by varying a camber line orientation from hub to shroud. The aforementioned twist or twist angle can be present at any point along the vane (e.g., at any point along a chamber line of the vane 302). For instance, the twist can be present at or rotate substantially about the trailing edge 316, as illustrated at 337, about the leading edge 314, as illustrated at 338, or another point such as at a midpoint between the trailing edge 316 and the leading edge 314, as illustrated at 339. The non-zero twist angles herein can be in a range from about -5 degrees to +5 degrees. For instance, in some embodiments that employ one or more cross-sectional layers with a positive twist (downstream) angle the positive twist can be a in a range from about 0.1 degrees to about 5.0 degrees. Similarly, in some embodiments that employ one or more cross-sectional layers with a negative twist (upstream) angle the negative twist can be in a range from about -0.1 degrees to about -5.0 degrees. The above twist angles are merely examples and can be varied, for instance depending on a particular design of a vane and/or turbocharger. Employing a non-zero twist angle can promote aspects herein such as controlling flow direction by varying the airfoil orientation along the vane height.

While various Figures herein illustrate a total of three cross-sectional layers 305, a total quantity of the cross-sectional layers can be varied. For instance, in some embodiments a total quantity or cross-sectional layers can be in a range from 2 to 100 cross-sectional layers, from 2 to 50 2 to 100 cross-sectional layers, from 2 to 10 cross-sectional layers, from 2 to 5 cross-sectional layers, from 3 to 10 cross-sectional layers, or from 3 to 5 cross-sectional layers, among other possible quantities.

In some embodiments, a chord length of two or more cross-sectional layers of a vane can have different chord lengths. For example, FIG. 4 illustrates an exploded view of a vane 402 of a fixed vane assembly herein, where the vane includes four cross-sectional layers 440-1, 440-2, 440-3, and 440-4 (collectively referred to herein as cross-sectional layers 440). The 3D vane 402 can be analogous to the 3D vane 302 described herein. As illustrated in FIG. 4, each cross-sectional layer of the cross-sectional layers 440 can have a different chord length between the leading edge 414 and the trailing edge 416 of the vane 402. For instance, a first cross-sectional layer 440-1 can have a first chord length 442-1 (e.g., 29.951 millimeters (mm)), a second cross-sectional layer 440-2 can have a second chord length 442-2 (e.g., 29.757 mm), a third cross-sectional layer 440-3 can have a third chord length 442-3 (e.g., 29.767 mm), and a fourth cross-sectional layer 440-2 can have a fourth chord length 442-4 (e.g., 29.757 mm).

In some embodiments, the outermost cross-sectional layers of the plurality of cross-sectional layers 400 can have different chord lengths. For instance, the first cross-sectional layer 440-1 can have a chord length (e.g., 29.951 mm) that is different than a chord length (e.g., 29.731 mm) of the fourth cross-sectional layers 440-4. In some embodiments, an outermost cross-sectional layer such as the first-cross sectional layer 440-1 that is most proximate to or is coupled to a platform (e.g., a hub) can have a chord length (e.g., 29.951 mm) that is longer than a chord length (e.g., 29.731 mm) of another outermost cross-sectional layer such as the fourth cross-sectional layer 440-4 that is most proximate to or is coupled to a different platform (e.g., a shroud).

As illustrated in FIG. 4, the first cross-sectional layers 440-1 can have chord length that is longer than a chord length each of the other cross-sectional layers (e.g., 440-2, 440-3, and 440-4). Stated differently, the outermost cross-sectional layers of the vane 402 can have different chord lengths.

In some embodiments, each of the one or more intervening layers can have different chord lengths. In some embodiments, at least one cross-sectional layer of the one or more intervening layers e.g., 440-2, can have a respective chord length that is shorter (less) than a chord length of an outermost cross-sectional layer 440-4 and at least one other cross-sectional layer of the one or more intervening layers e.g., 440-3 can have a respective chord length that is longer (greater) than the chord length of the outermost cross-sectional layer 440-4.

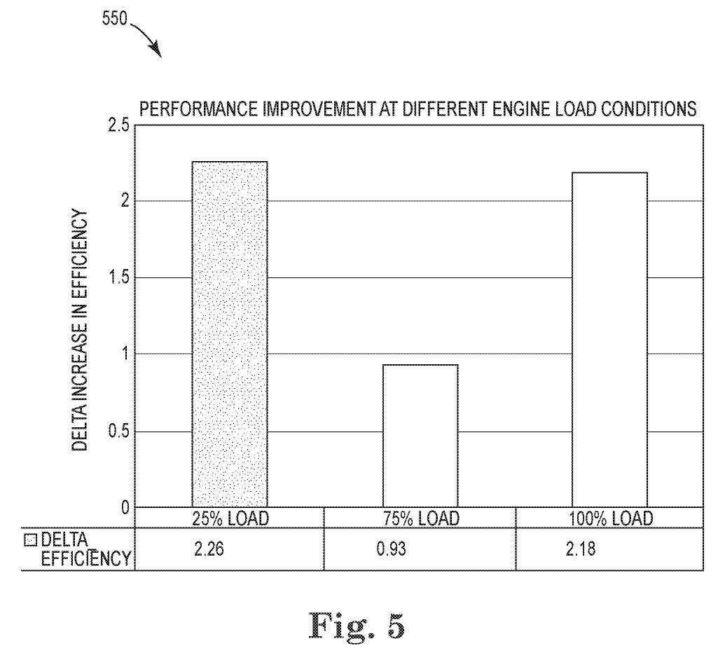

FIG. 5 illustrates a chart 550 displaying examples of performance improvements yielded by the fixed 3D vane assemblies herein. For example, the fixed 3D vane assemblies herein can yield performance improvements of approximately 2.26 points at 25% load (PR1.25), 0.93 points at 75% load (PR2.6), and 2.18 points at 100% load (PR4), as illustrated in the chart 550. Thus, the fixed nozzle assemblies herein can yield efficiency improvements of at least 0.9 points across engine load conditions between 25% and 100% load.

Each of these non-limiting examples can stand on its own, or can be combined in various permutations or combinations with one or more of the other examples. The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects. Method examples described herein can be machine or computer-implemented at least in part.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A fixed three-dimensional (3D) vane assembly for a turbocharger, the fixed vane assembly comprising:
one or more platforms including a shroud, a hub, or both a shroud and a hub; and
a plurality of 3D fixed airfoil vanes coupled to the one or more platforms, each of the fixed 3D airfoil vanes comprising a pair of flow surfaces disposed between a leading edge and a trailing edge and a hub surface and a shroud surface, wherein the flow surfaces are formed of a plurality of cross-sectional layers taken along the vane height of each of the fixed 3D airfoil vanes, and wherein at least two or more of the layers have a different cross-sectional airfoil shape.

2. The fixed vane assembly of claim 1, wherein the cross-sectional layers have different lean angles, different sweep angles, or both, relative to each other.

3. The fixed vane assembly of claim 1, wherein a portion of at least some of the cross-sectional layers have non-zero twist angles.

4. The fixed vane assembly of claim 3, wherein corresponding portions of the cross-sectional layers have different non-zero twist angles.

5. The fixed vane assembly of claim 4, wherein the trailing edge, the leading edge, or both of the trailing edge and the leading edge are configured at a non-zero sweep angle.

6. The fixed vane assembly of claim 4, the trailing edge and the leading edge are configured at a negative non-zero sweep angle.

7. The fixed vane assembly of claim 5, wherein:
a leading edge of a cross-section layer of the plurality of cross-sectional layers has a positive non-zero twist angle; and
a leading edge of an additionally cross-sectional layer of the plurality of cross-sectional layers has a negative non-zero twist angle.

8. The fixed vane assembly of claim 7, wherein the cross-sectional layer is a most proximate cross-sectional layer to a first platform, and wherein the additional cross-sectional layer is most proximate cross-sectional layer to a second platform.

9. The fixed vane assembly of claim 8, further comprising one or more intervening layers disposed along the vane height between the cross-sectional layer and the additional cross-sectional layer.

10. The fixed vane assembly of claim 9, wherein the one or more intervening layers has a twist angle that is between the positive non-zero twist of the cross-sectional layer and the negative cross-sectional twist of the additionally cross-sectional layer.

11. The fixed vane assembly of claim 1, wherein at least two cross-sectional layers of the plurality of cross-sectional layers have different chord lengths.

12. The fixed vane assembly of claim 1, wherein each cross-sectional layer of the plurality of cross-sectional layers has a different chord length.

13. The fixed vane assembly of claim 1, wherein a chord length of each of the outermost cross-sectional layers of the plurality of cross-sectional layers are longer than a chord length of one or more intervening cross-sectional layers of the plurality of cross-sectional layers.

14. The fixed vane assembly of claim 1, wherein a chord length of each of the outermost cross-sectional layers of the plurality of cross-sectional layers are different.

15. A turbocharger system comprising:
a turbine housing;
a turbine wheel within the turbine housing; and
a fixed three-dimensional (3D) vane assembly positioned upstream of the turbine wheel, the fixed vane assembly comprising: a plurality of 3D airfoil vanes, each 3D airfoil vane having multiple cross-sectional layers stacked along the vane height; wherein the multiple cross-sectional layers have different cross-sectional airfoil shapes and are arranged with variable lean and sweep angles relative to each other; wherein the multiple cross-sectional layers have non-zero twist angles that vary along the vane height, and wherein the multiple cross-sectional layers have different chord lengths.

16. The turbocharger system of claim 15, wherein each of the cross-sectional layers are configured at different lean angles relative to each other in the span (axial) direction for each of the fixed 3D airfoil vanes.

17. The turbocharger system of claim 15, wherein the 3D vane further comprises a first flow surface and a second flow surface positioned between a leading edge and a trailing edge of the 3D vane, and wherein the first flow surface, the second flow surface, or both the first flow surface and the second flow surface are configured at a non-zero lean angle.

18. A turbocharger nozzle assembly, comprising:
an inner platform;
an outer platform; and
a plurality of fixed three-dimensional (3D) vanes extending between the inner platform and the outer platform, each 3D vane having:
a compound stacked 3D airfoil geometry comprising multiple cross-sectional layers between a hub end and a shroud end;
a non-zero twist angle between -5 and +5 degrees that varies the orientation of the cross-sectional layers along the vane height;
a positive lean angle between 0 and 10 degrees; and
a negative sweep angle between 0 and -25 degrees;
wherein the compound stacked 3D airfoil geometry provides efficiency improvements of at least 0.9 points across engine load conditions between 25% and 100% load on the turbocharger nozzle assembly.

19. The turbocharger system of claim 18, wherein the multiple cross-sectional layers are stacked linearly along the vane height.

20. The turbocharger system of claim 18, wherein the multiple cross-sectional layers are stacked along a curved path along the vane height.
